(19) United States
(12) Patent Application Publication
(10) Pub. No.: US 2010/0187972 A1
(43) Pub. Date: Jul. 29, 2010

(54) COMPACT FLUORESCENT LAMP ENVELOPE AND METHOD OF MANUFACTURE

(76) Inventor: David Wartofsky, Accokeek, MD (US)

Correspondence Address: General Counsel, P.C., 6862 Elm Street, SUITE 800, McLean, VA, 22101, US

(21) Appl. No.: 12/360,407

(22) Filed: Jan. 27, 2009

(51) Int. Cl. H01J 1/62; H01J 9/00

(52) U.S. Cl. 313/493; 445/23

(57) ABSTRACT

Disclosed is an envelope for a compact fluorescent lamp composed of a core portion and a jacket portion. Either the core portion or the jacket portion may include a spiraling continuous protrusion that forms a spiraling cavity; the other member includes a surface dimensioned to sealingly contact the protrusion. The method of manufacturing the envelope includes inserting the core portion into a core channel formed by the jacket portion.

### FIELD OF THE INVENTION

The present invention relates to the field of lighting and more specifically to the field of compact fluorescent lighting.

### BACKGROUND

Compact fluorescent lamps (CFLs) available at the drafting of this document significantly reduce the amount of energy required to illuminate areas. CFLs on the whole tend to be too expensive or too large to permit wholesale replacement of incandescent bulbs for non-commercial applications. It is typical that CFLs found on the market possess tubes bent into various shapes, usually a helical coil, in an attempt to confine the overall dimensions of the CFLs to dimensions similar to the overall dimensions of conventional incandescent bulbs to permit CFLs to be used in residential applications. These tubes are generally 12-14 mm in diameter and wind away from a starting and then wind again in the direction of the starting point. These complex windings exist to increase the travel distance potential of ionized gas within the bulb, which is a prime determiner of the ability of the CFL to generate power efficiently. By increasing the length of the gas-containing tubes, the efficiency of the CFL increases. Many bulb envelope configurations have been proposed to solve the length dimension problem. Such configurations are generally restricted to multiple tube arrangements, coiled tube arrangements, and combinations thereof. Winding the delicate and often brittle materials that constitute lamp envelopes consumes time, attention, and mechanical dexterity. There is a need for a CFL with an envelope capable of simplified construction to diminish the costs of CFL devices.

### SUMMARY

The present invention is directed to a compact fluorescent lamp envelope and method for manufacturing the same. The envelope is composed of two envelope portions, an envelope core and an envelope jacket. In a core-ribbed embodiment of the present invention, the envelope core includes a core protrusion that spirals about an outer perimeter of the envelope core and along a height of the envelope core. Formed within the core and between the core protrusion segments is a continuous cavity. An envelope jacket includes a height that effectively covers the envelope core and an inner surface with an inner perimeter that seals the cavity. Disposed within the cavity is an ionizable vapor. An electrode accesses the cavity to energize the vapor therein. The protrusion, however, need not be located on the envelope core.

A jacket-ribbed embodiment of the present invention includes the envelope core and the envelope jacket with a spiraling jacket protrusion that circumscribes the inner surface of the jacket and winds up the jacket height. The jacket protrusion defines the cavity between adjacent jacket protrusion segments. The core includes a height and an outer surface with a perimeter that effectively seals the cavity of the jacket. Disposed within the cavity is the ionizable vapor. The electrode accesses the cavity to energize the vapor therein.

Embodiments of the present invention may include a spiraling extension cavity formed by the protrusion, either that of the jacket or the core, to further enhance the volume potential of the cavity of the present invention. The extension cavity is joined to the cavity by a bridge cavity, which is characterized by the alteration in pitch advantageous to join the cavity to the extension cavity. The preferred means of joining the envelope core to the envelope jacket is through size fitting, e.g. an interference fit or minimum clearance fit.

The method of the present invention includes inserting a version of the envelope core of the present invention into a version of the envelope jacket of the present invention. The pair may be longitudinally connected through straight fitting, or may be connected via spinning the jacket in relation to the core. The speed of insertion may be controlled to spin the jacket, in relation to the core, while utilizing a controlled speed to attempt to present a constant interaction between contacting surfaces of the jacket and core.

Therefore, it is an aspect of the present invention to provide a device capable of quick manufacture.

It is a further aspect of the present invention to provide a device of simplified manufacture.

It is a further aspect of the present invention to provide a compact fluorescent lamp envelope lacking protruding appendages yet maintaining a substantial volume for internal gas dispersion.

It is a further aspect of the present invention to a method of manufacture for the device of the present invention that minimizes injury to protruding components.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a perspective view of the envelope core of the present invention.

FIG. 2 is a perspective view of the envelope of the present invention.

FIG. 3 is a perspective view of the envelope of the present invention.

FIG. 4 is a perspective view of the envelope of the present invention.

FIG. 5 is a perspective view of the envelope of the present invention.

FIG. 6 is a perspective view of the assembled envelope of the present invention.

FIG. 7 is a perspective view of the envelope core of the present invention.

FIG. 8 is a sectional view of the envelope of the present invention.

FIG. 9 is a perspective view of the envelope core of the present invention.

FIG. 10 is a perspective view of the envelope core of the present invention.

FIG. 11 is a perspective view of the envelope core of the present invention.

FIG. 12 is a partial, perspective view of the envelope core of the present invention

### DETAILED DESCRIPTION

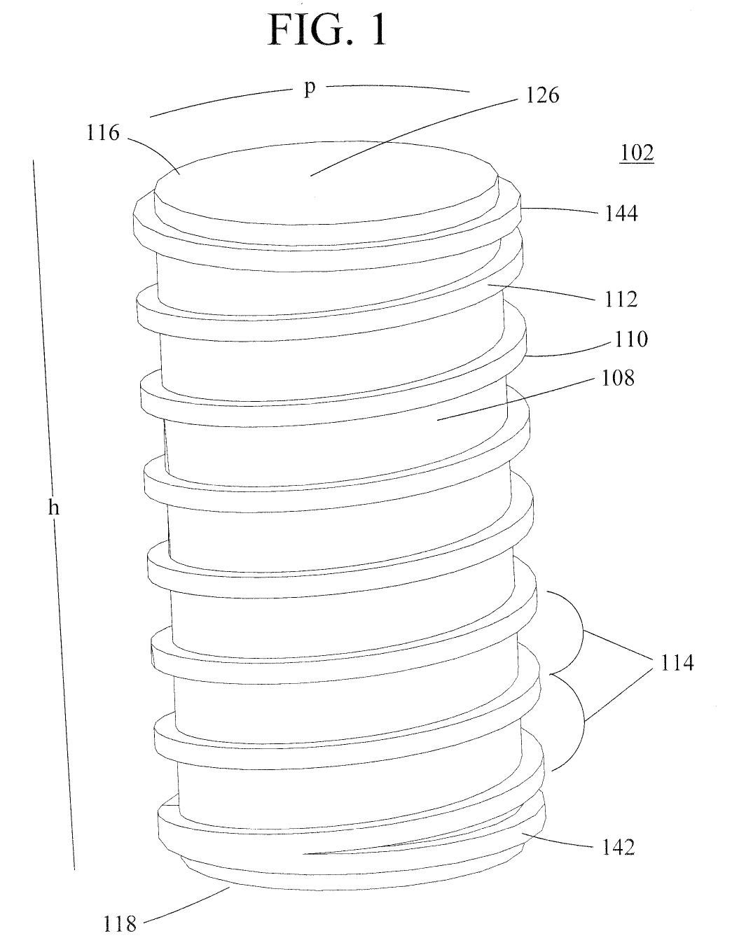

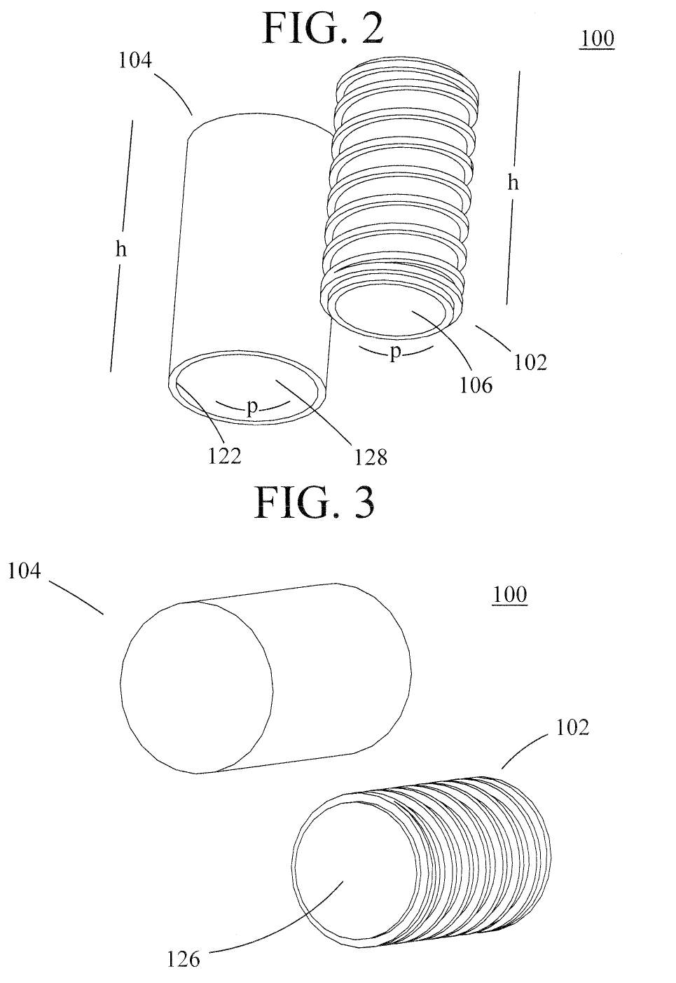

Referring first to FIGS. 1-3, a basic embodiment of the compact fluorescent lamp (CFL) envelope 100 is shown. In traditional incandescent bulbs, the envelope includes the covering that encases the filament of the bulb. In CFLs, the envelope expands its functional role and acts as the repository for ionizable gas, e.g. mercury vapor, within the bulb. The envelope 100 of the present invention serves to enclose ionizable gas (not shown) and offer access to any electromechanical components necessary to ionize the ionizable gas. The envelope includes an envelope core 102 and an envelope jacket 104.

A core-ribbed embodiment of the present invention is depicted in FIGS. 1-3, and includes the envelope core 102 with a protrusion 110 integrated into and extending from the envelope core. The envelope core 102 and envelope jacket 104 have substantial depth in three dimensions. That is to say, the present invention is not a substantially planar device. To maximize the properties related to power savings and the length of a container into which an ionizable gas is distributed, at least one dimension will extend to a greater degree than the other two. The substantially elongated portion of the envelope 100, and the envelope core 102 and envelope jacket 104 that comprise the envelope 100, includes a height, h; the remaining dimensions of the envelope 100, and the envelope core 102 and envelope jacket 104 that comprise the envelope 100, form a continuous perimeter, p. The perimeter, p, may discussed in reference to an envelope jacket inner surface 122, or a core jacket outer surface 124.

The protrusion 110 spirals around the perimeter, p, and along the height, h, such that the path formed by the protrusion includes a non-zero pitch. As the protrusion 110 winds its way along the height, h, a continuous cavity 108 is formed between a repeating series of protrusion nodes 114. By nodes 114, or segments, it is meant those portions of the protrusion 110 that are co-planar, in the direction of the height, h, of an envelope portion. As the pitch of the protrusion 110 spiral increases, fewer nodes will be present on the envelope 100, and vice versa. A diminished pitch allows a greater degree of length to exist between the extremities of the cavity 108.

The cavity 108 travels along the height, h, from a core origin 118 to a core terminus 116. The terms origin and terminus are used in the present disclosure merely as reference points for purposes of simplified discussion, although the core origin may be considered to be the portion of the envelope more proximate, relative to the core terminus, to the attachment point of any lamp containing the envelope of the present invention, the ability to distribute lamp components makes any such designation of origin and terminus arbitrary. The envelope core 102 preferably forms a component channel 106 proximate to the core origin 118. The component channel may extend longitudinally through the interior of the core envelope 102 to the core terminus 116, which may terminate in a solid apex surface 126 or extend throughout the entirety of the envelope core 102.

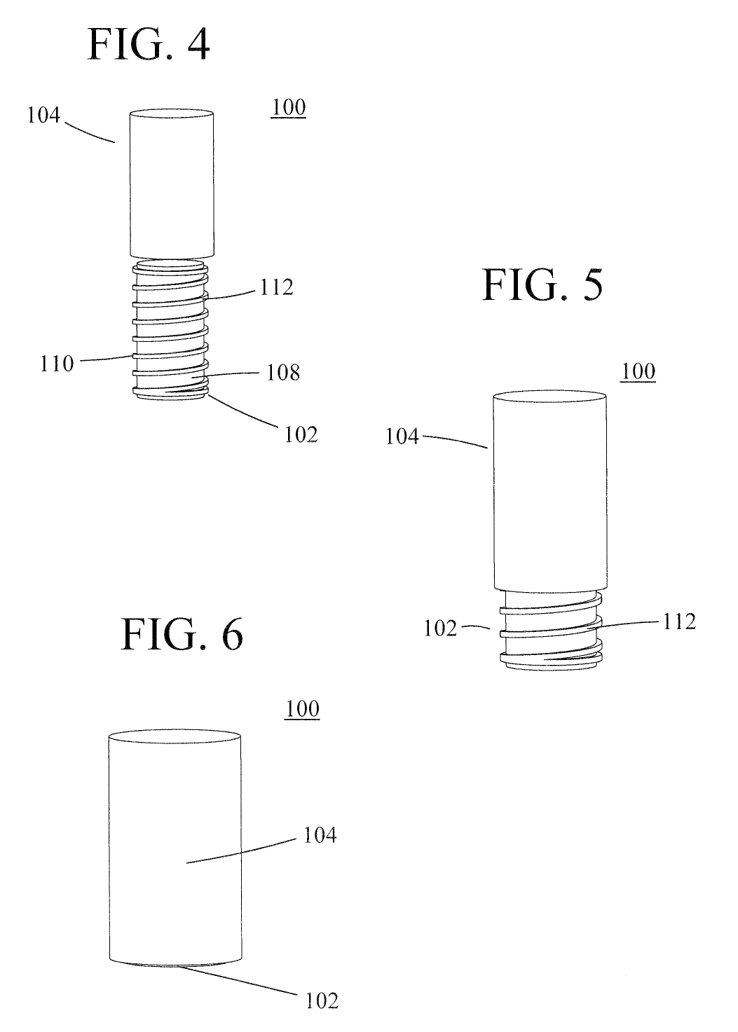

As the envelope core 102 may include a component channel 106 that extends partially or wholly through the interior of the envelope core 102, the envelope jacket 104 includes a core channel 128 formed by the interior surface 122 of the envelope jacket 104 that may extend wholly or partially throughout the interior of envelope jacket 104. The core channel 128 in the envelope jacket 104 is dimensioned to accept and enclose the envelope core 102. The length of both the component channel 106 and the core channel 128 may be predicated on the multiple criteria, including heat dissipation and core/jacket sealing. It is preferred that the core channel 128 extend to enclose a portion of the envelope core 102 approximately equal to the height of the envelope core 102. The interior surface 122 of the envelope jacket 104 includes an inner perimeter. The core protrusion 110 includes a core protrusion surface 112 that defines the core outer perimeter dimensioned to match closely the dimensions of the inner perimeter of the envelope inner surface 122. As can be seen in FIGS. 4-6, the envelope core 102 slides into the interior of the envelope jacket 104 such that the core protrusion surface 112 contacts the envelope jacket inner surface (not shown) to create a minimum clearance fit or interference fit therewith. Upon engagement, the envelope inner surface forms a ceiling to the open-topped cavity 108 formed by the spiraling protrusion 110 to seal to the cavity 108. A cavity is sealed when the travel path of ionizable vapor in the cavity 108 is restricted longitudinally by the fit of the core protrusion surface 112 and the envelope jacket inner surface.

Returning to FIG. 1, the envelope core 102 and core jacket 104 may be formed by molding, which allows the protrusion 110 to include non-uniform shapes and sizes. In molded embodiments in particular, the formation of a lower stop 142 and an upper stop 144. The stops 142, 144 of the present invention form bounds for the extremities of the cavity 108 and may include a simple longitudinal wall spanning merely the distance directly between adjacent nodes, or a transverse wall wrapping about the perimeter of either the envelope jacket or the envelope core. The height of the envelope jacket 104 preferably extends from the farthest extremity 142 of the lower stop to the farthest extremity, relative to the lower stop, of the upper stop 144.

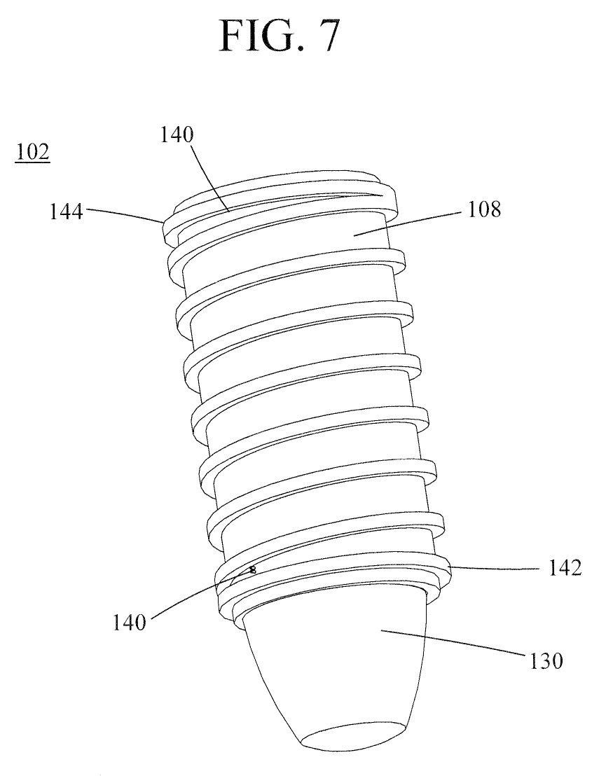

Turning now to FIG. 7, integrated embodiments of the present invention may include an envelope core 102 affixed, or removably inserted into, a cap 130. The cap 130 serves two functions: to allow connection to a light fixture, and house electronic components of the present invention. The cap 130 may house CFL components common in the art, such as a magnetic or electronic ballast. Electronic ballasts may contain a circuit board with rectifiers, a filter capacitor, and switching transistors connected as a high-frequency resonant series DC to AC inverter. Electrodes 140 exciting the ionizable vapor of the present invention are positioned within the cavity 108 at the extremities of the cavity 108 in electrical communication with the ballast, which may be housed within the cap 130. Depending on the brittleness and structural integrity of the material utilized fabricating the envelope, the electrodes may puncture the envelope to access the cavity, or may be inserted through predefined channels dimensioned to accept the electrodes. Preferred positioning for the electrodes includes a position directly adjacent to the stops, 142, 144. The cavity 108 forms a continuous arc path, the extremities of which include electrodes and lead-in wires connected to the electrodes. The lead-in wires arrangement may be connected to the ballast circuit for controlling the current in the envelope. The ballast circuit is further connected to a supply voltage through lead-out wires that are connected to appropriately located contact terminals. The exterior of the cap may include any structure for attaching to common or novel lamp fixtures, including a threaded surface. The present invention may also include non-integrated embodiments that include merely the envelope adapted to attach to permanent ballasts.

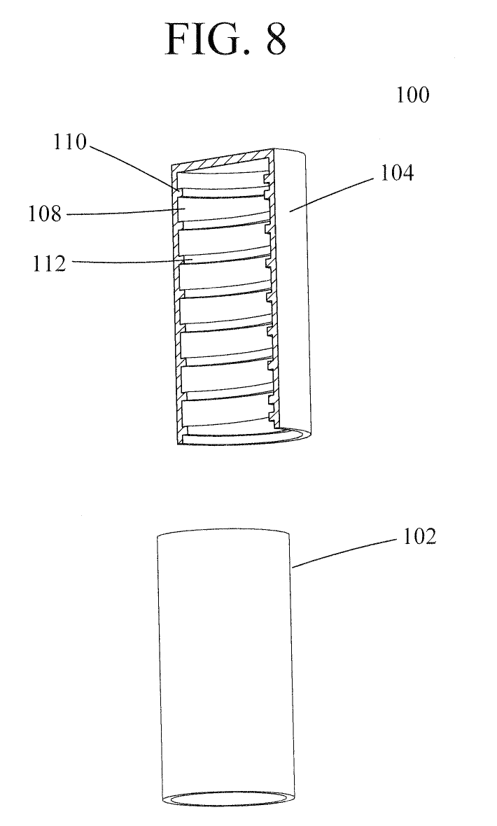

As FIG. 8 depicts, jacket-ribbed embodiments of the present invention may include an envelope jacket 104 bearing the spiraling protrusion 110. The protrusion 110 extends inwardly from the envelope jacket 104 to present a central protrusion surface 112. The central protrusion surface 112 of the envelope jacket 104 slides over the envelope core 102 to seal the envelope jacket 104 upon the core 102, sealing the cavity 108 formed by the spiraling protrusion 110.

The envelope jacket 104 as depicted in FIG. 8 and the envelope core 102 as depicted in FIG.1 may be utilized in a multiple protrusion embodiment. The multiple protrusion embodiment includes a jacket 104 bearing a jacket spiraling protrusion 110 and a core 102 bearing a core spiraling protrusion 110. The core spiraling protrusion and the jacket spiraling protrusion are dimensioned to form the seal fit of the present invention with mating surfaces of the respective protrusions. That is to say, the jacket includes a spiraling protrusion and the core includes a spiraling protrusion and each member's spiraling protrusion interacts with the spiraling protrusion of the mating member to form one or more sealed cavities. A preferred version of the multiple protrusion embodiments includes a configuration as follows: the protrusion of one member, either the core or jacket, may be dimensioned to screw into the cavity formed by the protrusion of the opposite member, either the core or the jacket. Each protrusion forms a cavity, which acts as the track for the placement of the protrusion of the other, mating member. The protrusion may occupy a protrusion transverse height less than or equal in magnitude to the depth of the cavity into which it fits.

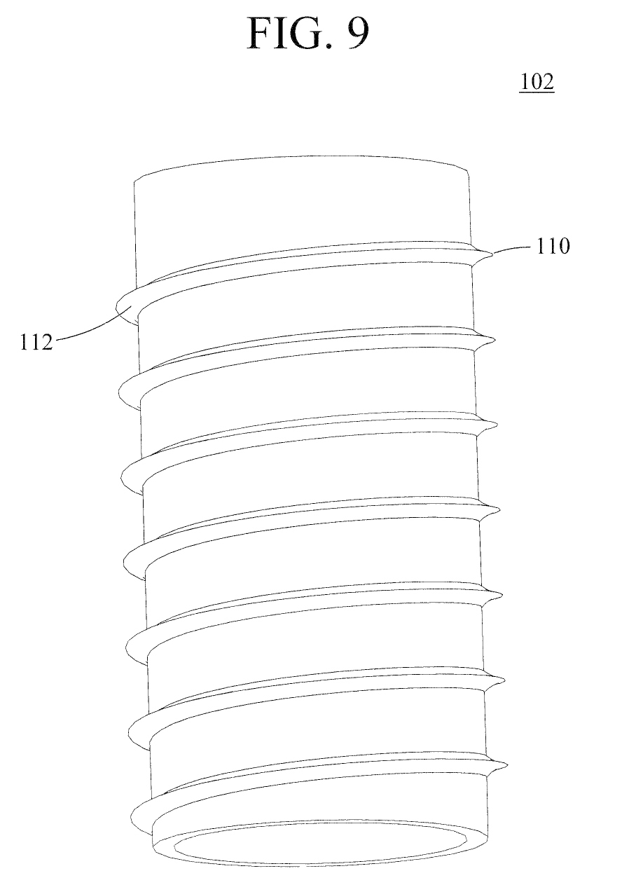

FIG. 9 shows a pliable-protrusion embodiment of the present invention. The envelope may include an envelope core 102 or envelope jacket (not shown) with the protrusion 110 fashioned from a pliable material and dimensioned to allow longitudinal distortion of the protrusion. That is to say, as the mating member is slipped over the member bearing the pliable protrusion, the receding girth permits the protrusion 110 to dislocate in the direction of the longitudinal motion of the other member to form a seal fit based on the inherent longitudinal elasticity of the protrusion material. Plastic and rubber protrusions that diminish in girth transversely relatively to the envelope are preferred. Any protrusion may be constructed wholly or partially of a pliable material. The embodiments bearing a substantially planar surface, particularly for example those of FIGS. 1-8, may include a transversely pliable protrusion adapted to recede into the envelope rather than along the height thereof. Compression in addition to, or in place of, adhesives may be used to provide the seal fit of the present invention.

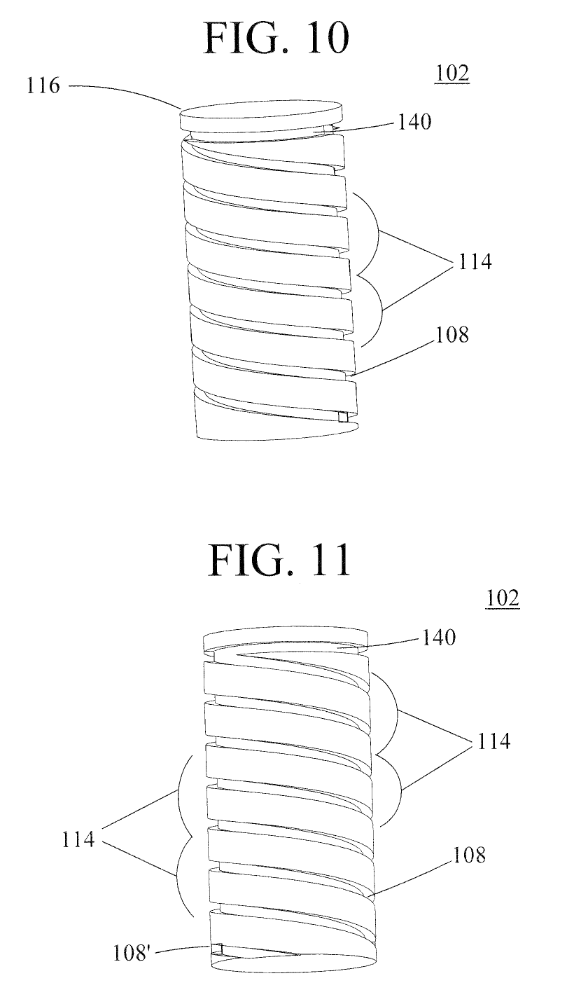

As FIGS. 10-12 depict, the present invention may include multiple windings of cavity channels in the same fashion that common CFLs utilize multiple windings of bulb shells. The spiraling protrusion 110 of the depicted envelope core 102 includes a relatively increased pitch suitable to achieve two objectives: create a winding cavity 108 path to the terminus 116 of the envelope core 102, and allow protrusion space sufficient to allow a cavity extension 108′ to wind between the winding passage of the cavity 108. The cavity 108 extends longitudinally along the envelope core 102 where the pitch of the cavity diminishes to form a cavity bridge 140. The cavity bridge 140 is in gaseous communication with the cavity 108 and exists to allow the cavity 108 to assume a pitch substantially distinct from the pitch of the cavity 108. The preferred cavity bridge 140 includes a pitch of 0 degrees and spans between 15 degrees and 345 degrees of the perimeter of the envelope core 102. As the cavity bridge 140 includes an inlet that permits the cavity bridge 140 to be in gaseous communication with the cavity 108, it also includes an outlet that permits the cavity bridge 140 to be in gaseous communication with the cavity extension 108′.

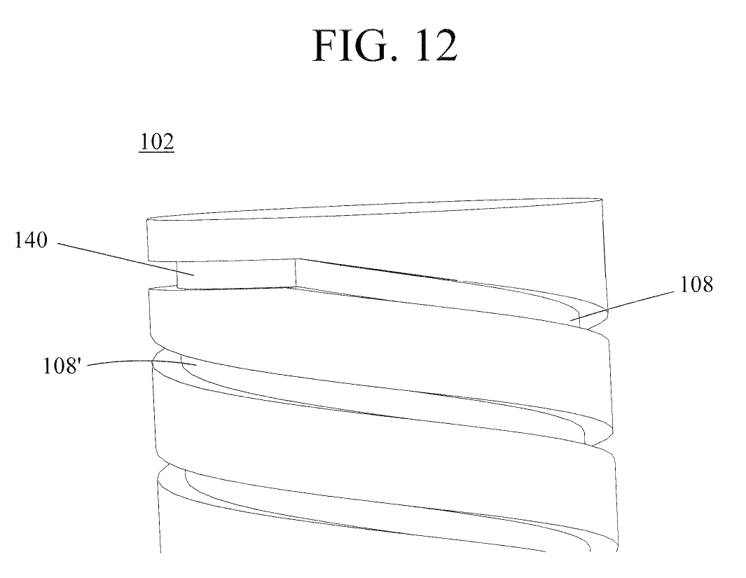

As specifically depicted in FIG. 12, it is most preferred that the cavity bridge outlet is positioned approximately 180 degrees from the cavity bridge inlet and the cavity extension includes a pitch that is the negative of, but equal in magnitude, to the pitch of the cavity. In this preferred position, it is further preferred that the cavity bridge span only the distance about the perimeter of the pertinent member necessary to extend from the cavity to the cavity extension. Thus if the cavity includes a pitch of angle Ω, then the cavity extension preferably includes a pitch of −Ω. Such a configuration places the travel path of the cavity extension well within the protrusion forming the cavity. As the cavity, cavity bridge, and cavity extension form a continuous channel in either the envelope core or envelope jacket, it is appropriate to consider the combination a single entity, but they are dissected according to pitch differentiation for the purposes of clarity in the present disclosure. In embodiments of the present invention with cavities of multiple pitch changes, it is preferred to locate any electrodes at the extremities of any combination of cavities formed thereby. In the single cavity embodiment depicted in FIG. 7, for example, only a single cavity exists that winds from the core origin 118 to the core terminus 116; however, the envelope core embodiment of FIGS. 10-11 include a cavity that winds from origin 118 to terminus 116, around the terminus 116, and then back down to the origin 118. The combination of cavities of the embodiment of FIGS. 10-11 begins and ends proximate to the origin 118; thus, it is preferred that any electrodes (not shown) be positioned at the extremities therein. The travel distance of the vapor within the cavity determines the positioning of the electrodes rather than actual physical distances between points within the cavity.

The envelope core and envelope jacket of the present invention may be formed of any number of subcomponents and includes any shape suitable to achieve the aspects of the present invention. Multiple envelope shapes contemplated by the present invention may be advantageously created in multiple subparts for facile construction. The envelope may include the shapes of a sphere, preferably subdivided into at least two jacket subportions and a unitary or at least two core subportions; a cone, truncated or non-truncated; a incandescent light bulb shape that mimics the dimensions of any preexisting conventional light bulb with the characteristic, roughly sphere-on-cylinder shape—preferably subdivided into four jacket portions transversely along the union of the sphere and cylinder and longitudinally by half, and with a unitary or similarly subdivided core.

The envelope core and envelope jacket may be formed according to any standard formation process applicable to bulb materials. Any material capable of retaining the ionizable vapor of the present invention may be utilized in the construction of the envelope. Preferred materials include glass, quartz, plastic, and the like. Sealants for the present invention include any bonding agent, compressible material, or other adhesive suitable to sealingly join materials used in the envelope construction. The envelope core is inserted into core channel of the envelope jacket. Preferred means for insertion may include rotating either the envelope core or envelope jacket during the insertion. This rotation is particularly preferred for envelopes constructed of more delicate materials. Rotation of the core with respect to the jacket permits force to be applied in multiple directions rather than supply a force restricted along a single dimension. It may be advantages to rotate the core with respect to the jacket at a rotation rate and insertion rate such that a portion of a component, either core or jacket, not possessing the protrusion remains in constant contact with the protrusion upon surfaces in contact with the protrusion, and similarly portions not in contact with the protrusion remain out of contact with the protrusion throughout the entirety of the insertion process. It is preferred to rotate the component, either the core or jacket, not possessing a protrusion in the direction of the protrusion pitch to prevent a given portion of that component from the rigors of intermittent contact.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A compact fluorescent lamp envelope comprising:
an envelope core with an outer perimeter, a core height, and defining a spiraling core protrusion of non-zero pitch with a core protrusion surface, said protrusion circumscribing said core outer perimeter elevated along said core height to provide multiple protrusion nodes along said core height, wherein said core protrusion defines a cavity continuous for at least two protrusion nodes and bounded by adjacent protrusion nodes;
an envelope jacket with a jacket height dimensioned to span at least two protrusion nodes and a jacket inner surface having a jacket inner perimeter adapted to sealingly engage said core protrusion surface for at least two protrusion nodes;
an ionizable vapor disposed within said cavity; and
an electrode assembly in electrical communication with said cavity.

2. The lamp envelope of claim 1 wherein said core protrusion defines: a cavity bridge, in gaseous communication with said cavity, characterized by a diminished pitch along said core height, and a spiraling extension cavity, in gaseous communication with said cavity bridge, and having a pitch substantially opposite that of said cavity such that said cavity and said extension cavity do not intersect.

3. The lamp envelope of claim 2 wherein said electrode assembly includes electrode means positioned within said cavity and within said extension cavity, gaseously separated by at least two nodes and at least two extension nodes.

4. The lamp envelope of claim 1 wherein said protrusion defines a lower stop having a uniform lower stop perimeter, an upper stop perimeter having a uniform upper stop perimeter, wherein said cavity spans said core height from said lower stop to said upper stop and said envelope jacket includes a height at least equal in magnitude to a physical separation distance of said upper stop and said lower stop.

5. The lamp envelope of claim 1 wherein said core outer surface and said jacket inner surface are rigid; and said core protrusion surface includes a pliable portion adapted to dislocate in response to contact from said jacket inner surface.

6. The lamp envelope of claim 5 wherein said pliable core protrusion surface portion includes a compression pad adapted to transversely compress into said core upon contact with said jacket.

7. The lamp envelope of claim 5 wherein said pliable core protrusion surface portion includes a continuous, flexible wing of diminishing girth adapted to dislocate longitudinal to said core upon contact with said jacket.

8. A compact fluorescent lamp envelope comprising:
an envelope jacket with a jacket inner perimeter and a jacket height, and defining a spiraling jacket protrusion of non-zero pitch, with a jacket protrusion surface, circumscribing said jacket inner perimeter elevated along said jacket height to provide multiple protrusion nodes along said jacket height, wherein said jacket protrusion defines a cavity continuous for at least two protrusion nodes and bounded by adjacent protrusion nodes;
an envelope core with a core height dimensioned to span at least two protrusion nodes and a core outer surface having a core outer perimeter adapted to sealingly engage said jacket protrusion surface for at least two protrusion nodes;
an ionizable vapor disposed within said cavity; and
an electrode assembly in electrical communication with said cavity.

9. The lamp envelope of claim 8 wherein said jacket protrusion defines: a cavity bridge, in gaseous communication with said cavity, characterized by a diminished pitch along said jacket height, and a spiraling extension cavity, in sealed gaseous communication with said cavity bridge, and having a pitch substantially opposite that of said cavity such that said cavity and said extension cavity do not intersect.

10. The lamp envelope of claim 9 wherein said electrode assembly includes electrode means positioned within said cavity and within said extension cavity, gaseously separated by at least two nodes and at least two extension nodes.

11. The lamp envelope of claim 8 wherein said protrusion defines a lower stop having a uniform lower stop perimeter, an upper stop perimeter having a uniform upper stop perimeter; said cavity spanning along said jacket height from said lower stop to said upper stop.

12. The lamp envelope of claim 8 wherein said jacket inner surface and said core outer surface are rigid; and said jacket protrusion surface includes a pliable portion adapted to dislocate in response to contact from said core outer surface.

13. The lamp envelope of claim 12 wherein said pliable jacket protrusion surface portion includes a compression pad adapted to transversely compress into said jacket upon contact with said core.

14. The lamp envelope of claim 12 wherein said pliable core surface protrusion portion includes a continuous, flexible wing of diminishing girth adapted to dislocate longitudinal to said jacket upon contact with said core.

15. A method of manufacturing a compact fluorescent lamp envelope, said method comprising:
inserting an envelope core into an envelope jacket, wherein said envelope core includes: an outer perimeter, a core height, and defining a spiraling core protrusion, with a core protrusion surface, circumscribing said core outer perimeter elevated along said core height to provide multiple protrusion nodes along said core height, wherein said core protrusion defines a cavity continuous for at least two protrusion nodes and bounded by adjacent protrusion nodes; and
wherein said envelop jacket includes: a jacket height dimensioned to span at least two protrusion nodes and a jacket inner surface having a jacket inner perimeter adapted to sealingly engage said core protrusion surface for at least two protrusion nodes, such that said envelope sequentially contacts said protrusion nodes;
distributing within said cavity an ionizable vapor; and
affixing an electrode assembly in electrical communication with said cavity.

16. The method of claim 1 5 wherein said inserting step includes rotating said jacket with respect to said core in a direction complementary to said spiraling core protrusion.

17. The method of claim 16 wherein said inserting step includes positioning said envelope with respect to said core at a rate related to the pitch of said spiraling core protrusion such that a point on said core is pre-calculated to have a constant interaction with said jacket.

18. A method of manufacturing a compact fluorescent lamp envelope, said method comprising:
inserting an envelope core, wherein said envelope core includes: a core height dimensioned to span at least two protrusion nodes and a core outer surface having a core outer perimeter adapted to sealingly engage said jacket protrusion surface for at least two protrusion nodes, into an envelope jacket, wherein said envelop jacket includes: a jacket inner perimeter and a jacket height, and defining a spiraling jacket protrusion, with a jacket protrusion surface, circumscribing said jacket inner perimeter elevated along said jacket height to provide multiple protrusion nodes along said jacket height, wherein said jacket protrusion defines a cavity continuous for at least two protrusion nodes and bounded by adjacent protrusion nodes;
distributing within said cavity an ionizable vapor; and
affixing an electrode assembly in electrical communication with said cavity.

19. The method of claim 18 wherein said inserting step includes rotating said jacket with respect to said core in a direction complementary to said spiraling jacket protrusion.

20. The method of claim 19 wherein said inserting step includes positioning said envelope with respect to said core at a rate related to the pitch of said spiraling jacket protrusion such that a point on said core is pre-calculated to have a constant interaction with said jacket.

21. A compact fluorescent lamp envelope comprising:
an envelope core with a core height and a core outer surface having a core outer perimeter,
an envelope jacket with a jacket height and a jacket inner surface having a jacket inner perimeter;
a spiraling envelope partition wall, spanning both said core outer perimeter and said jacket inner perimeter, contacting said core surface outer surface and said jacket inner surface to form a helical cavity with a non-zero pitch along said core height and said jacket height and forming multiple partition nodes along said core height and said jacket height, and said helical cavity is continuous for at least two partition nodes;
an ionizable vapor disposed within said cavity; and
an electrode assembly in electrical communication with said cavity,
wherein said partition wall is adapted to sealingly engage said cavity about said core outer surface and said jacket inner surface for at least two partition nodes.
